(19) United States
(12) Patent Application Publication
(10) Pub. No.: US 2026/0147262 A1
(43) Pub. Date: May 28, 2026

(54) PROJECTION APPARATUS

(71) Applicant: Coretronic Corporation, Hsin-Chu (TW)

(72) Inventors: Yu-Hsiang Deng, Hsin-Chu (TW); Jui Chang, Hsin-Chu (TW)

(73) Assignee: Coretronic Corporation, Hsin-Chu (TW)

(21) Appl. No.: 19/377,041

(22) Filed: Nov. 3, 2025

(30) Foreign Application Priority Data
Nov. 22, 2024 (CN) 202411679032.9

(51) Int. Cl. G03B 21/20; G02B 26/00

(52) U.S. Cl. CPC G03B 21/204; G02B 26/008; G03B 21/2053; G03B 21/2066; G03B 21/208

(57) ABSTRACT

A projection apparatus including a case, a light source module, a first dichroic mirror, and a wavelength conversion wheel is provided. The first dichroic mirror is disposed on a transmission path of a first color light provided by the light source module. The wavelength conversion wheel is disposed on a transmission path of the first color light from the first dichroic mirror, and includes a substrate. A surface of the substrate is parallel to a bottom surface of the case and is provided with a wavelength conversion area and a reflection area. The wavelength conversion area converts the first color light into a second color light and reflects the second color light to the first dichroic mirror within a first time interval. The reflection area reflects the first color light back to the first dichroic mirror within a second time interval.

### CROSS-REFERENCE TO RELATED APPLICATION

This application claims the priority benefit of China application serial no. 202411679032.9, filed on Nov. 22, 2024. The entirety of the above-mentioned patent application is hereby incorporated by reference herein and made a part of this specification.

### BACKGROUND

### Technical Field

The disclosure relates to an optical system, and particularly relates to a projection apparatus.

### Related Art

A projection apparatus (for example, a projector) is a display apparatus used for projecting large-area images, and continues to advance with technological development and innovation. The imaging principle of such a projection apparatus is to convert the illumination light generated by an illumination system into an image beam through a light valve, and then project the image beam through a projection lens onto a projection target (for example, a screen or wall) to form a projected image. In order to display color, the illumination system may utilize solid-state light-emitting elements (for example, laser diode elements or light-emitting diode elements), or laser diode elements in combination with a wavelength conversion element as the illumination light source.

Generally, the light source and optical elements in the projection apparatus are arranged on the same horizontal plane (for example, XY plane), allowing the light-receiving surface of the wavelength conversion element to be perpendicular to the bottom surface of the case of the projection apparatus. Therefore, a larger space is occupied on the horizontal plane (XY plane). To reduce the occupied space on the horizontal plane, some current projection apparatuses may configure some of the optical elements at different heights (arranged in Z direction). However, to guide the illumination light to different heights, additional reflection mirrors are required, which makes it difficult to reduce the overall size of the optical engine and increases the costs.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

The disclosure provides a projection apparatus whose body occupies a smaller space and which has better stability in the light traveling path of the illumination system. The wavelength conversion wheel of the projection apparatus has improved stability and reduces vibration and noise during rotation.

Other objectives and advantages of the disclosure may be further understood from the technical features disclosed herein.

To achieve one or part or all of the above objectives or other objectives, an embodiment of the disclosure provides a projection apparatus. The projection apparatus includes a case, an illumination system, a light valve, and a projection lens. The illumination system is disposed in the case. The illumination system provides an illumination light, and the illumination system includes a light source module and a wavelength conversion wheel. The light source module provides a first color light. The wavelength conversion wheel is disposed on a transmission path of the first color light, and includes a substrate. A wavelength conversion area is disposed on a surface of the substrate. The wavelength conversion area converts the first color light into a second color light. The light valve is disposed on a transmission path of the illumination light, and converts the illumination light into an image beam. The projection lens is disposed on a transmission path of the image beam, and projects the image beam out of the projection apparatus. The surface of the substrate is parallel to a bottom surface of the case. The bottom surface of the case supports the weight of the illumination system.

In an embodiment of the disclosure, the illumination system further includes a first dichroic mirror. The first dichroic mirror is disposed on the transmission path of the first color light, and the wavelength conversion wheel is disposed on the transmission path of the first color light from the first dichroic mirror.

In an embodiment of the disclosure, the substrate further includes a reflection area. The reflection area reflects the first color light. The substrate drives the wavelength conversion area and the reflection area to rotate around a rotation axis, so that the wavelength conversion area converts the first color light into a second color light and reflect the second color light to the first dichroic mirror within a first time interval, and the reflection area reflects the first color light to the first dichroic mirror within a second time interval. The rotation axis is parallel to a gravity direction.

In an embodiment of the disclosure, the illumination system further includes a filter module. The filter module is disposed on transmission paths of the second color light and the first color light from the first dichroic mirror.

In an embodiment of the disclosure, the illumination system further includes a light-homogenizing element. On the transmission path of the illumination light, the light-homogenizing element is disposed between the filter module and the light valve.

In an embodiment of the disclosure, the projection apparatus further includes a prism group disposed on the transmission path of the illumination light, and guiding the illumination light to the light valve.

In an embodiment of the disclosure, the light valve has a light modulation surface parallel to the gravity direction, and the light modulation surface is perpendicular to the bottom surface of the case. The light modulation surface has a first edge and a second edge perpendicular to each other. The first edge is parallel to the bottom surface of the case, and an orthographic projection of an optical path of the illumination light from the prism group on the light modulation surface is not parallel to the first edge and the second edge.

In an embodiment of the disclosure, the illumination system further includes a first reflection mirror disposed on the transmission path of the first color light from the light source module. The first color light from the light source module transmits along a first direction, and after being reflected by the first reflection mirror, transmits along the gravity direction to the first dichroic mirror. In an embodiment of the disclosure, in the gravity direction, the first dichroic mirror is located between the first reflection mirror and the wavelength conversion wheel, and is configured to allow the first color light to pass through and reflect the second color light.

In an embodiment of the disclosure, the second color light from the wavelength conversion wheel transmits along the first direction to the filter module after being reflected by the first dichroic mirror.

In an embodiment of the disclosure, the illumination system further includes a diffusion element disposed on the transmission path of the first color light from the wavelength conversion wheel.

In an embodiment of the disclosure, the illumination system further includes a second dichroic mirror disposed on the transmission path of the first color light from the diffusion element. The second color light from the first dichroic mirror passes through the second dichroic mirror and transmits to the filter module, and the first color light from the diffusion element transmits to the filter module after being reflected by the second dichroic mirror.

In an embodiment of the disclosure, the illumination system further includes a second reflection mirror and a third reflection mirror. The second reflection mirror reflects the first color light from the wavelength conversion wheel to the diffusion element, and the third reflection mirror reflects the first color light passing through the diffusion element to the second dichroic mirror.

In an embodiment of the disclosure, in the gravity direction, the wavelength conversion wheel is disposed between the light source module and the bottom surface of the case. In an embodiment of the disclosure, the first dichroic mirror has a first area and a second area. The first area is configured to allow the first color light to pass through and reflect the second color light, and the second area is configured to allow a first portion of the first color light from the wavelength conversion wheel to pass through, and reflect a second portion of the first color light from the wavelength conversion wheel and the second color light.

In an embodiment of the disclosure, the illumination system further includes a second reflection mirror, and the second reflection mirror is configured to reflect the first portion of the first color light passing through the second area of the first dichroic mirror.

Based on the above, in the projection apparatus of an embodiment of the disclosure, the substrate of the wavelength conversion wheel is provided with the reflection area for reflecting the first color light emitted by the light source module and the wavelength conversion area for converting the first color light into the second color light. Since the surface of the substrate is parallel to the bottom surface of the case of the projection apparatus, the stability of the wavelength conversion wheel during rotation is improved, which helps reduce vibration and noise generated during the rotation process. In addition, the number of optical elements to be disposed is reduced, thereby reducing the overall size of the projection apparatus.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 is a schematic side view of the projection apparatus according to the first embodiment of the disclosure.

FIG. 2 is a schematic top view of the projection apparatus according to the first embodiment of the disclosure.

FIG. 3A and FIG. 3B are schematic views of the wavelength conversion wheel in FIG. 1 and FIG. 2.

FIG. 4 is a schematic views side view of the projection apparatus according to the second embodiment of the disclosure.

FIG. 5 is a schematic views top view of the projection apparatus according to the second embodiment of the disclosure.

FIG. 6 is a schematic enlarged view of the first dichroic mirror in FIG. 4 and FIG. 5.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

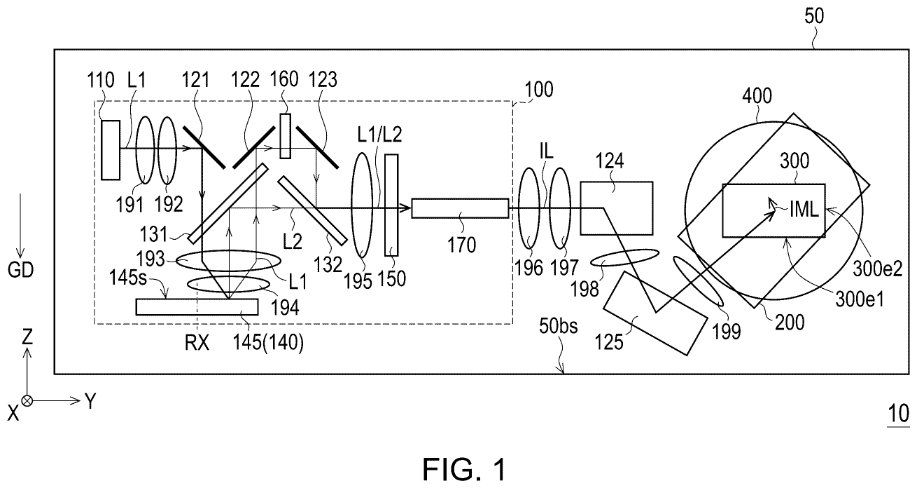

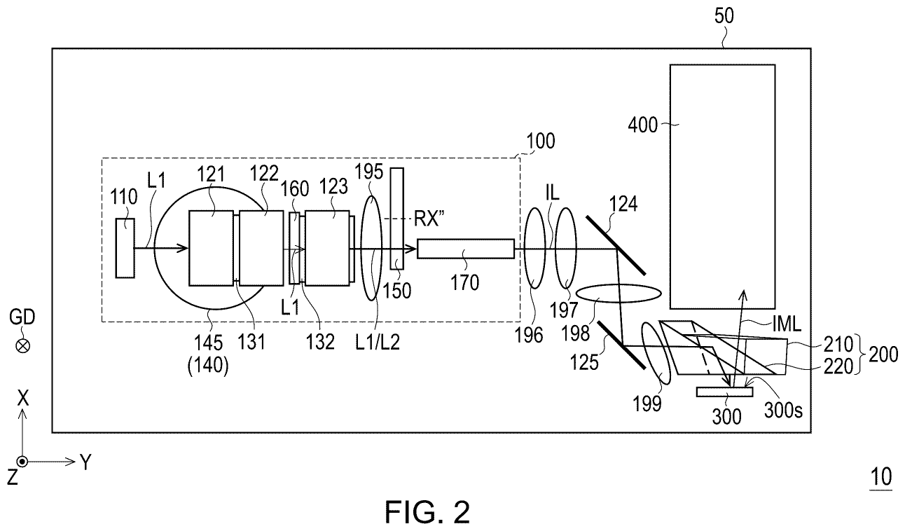

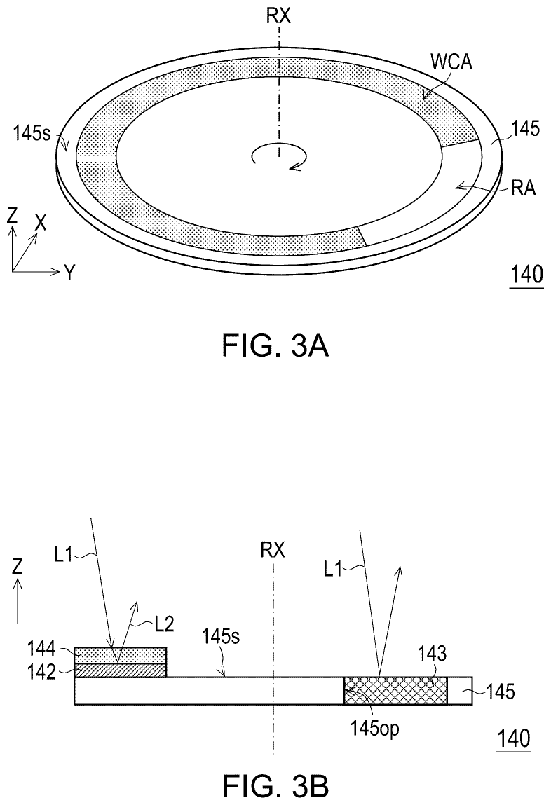

FIG. 1 is a schematic side view of the projection apparatus according to the first embodiment of the disclosure. FIG. 2 is a schematic top view of the projection apparatus according to the first embodiment of the disclosure. FIG. 3A and FIG. 3B are schematic views of the wavelength conversion wheel in FIG. 1 and FIG. 2. For clarity, the illustration of the lens 191 and the lens 192 in FIG. 1 is omitted in FIG. 2.

Referring to FIG. 1 and FIG. 2, a projection apparatus 10 includes a case 50 and an illumination system 100. The illumination system 100 is disposed in the case 50 and configured to provide an illumination light IL. The illumination system 100 includes a light source module 110, a first dichroic mirror 131, and a wavelength conversion wheel 140. The light source module 110 is configured to provide a first color light L1. In this embodiment, the light source module 110 includes at least one laser element, but the disclosure is not limited thereto. The laser element is, for example, a laser diode. In other embodiments, the light source module 110 may include at least one LED (light emitting diode). The first dichroic mirror 131 is disposed on the transmission path of the first color light L1, and is configured to allow the first color light L1 to pass through. In this embodiment, the first color light L1 is, for example, a blue light, but the disclosure is not limited thereto.

The wavelength conversion wheel 140 is disposed on the transmission path of the first color light L1 from the first dichroic mirror 131. Referring to FIG. 1, FIG. 3A, and FIG. 3B, the wavelength conversion wheel 140 includes a substrate 145, and the substrate 145 is provided with a wavelength conversion area WCA and a reflection area RA. The wavelength conversion area WCA is disposed on a surface 145s of the substrate 145. A motor drives the substrate 145 to rotate the wavelength conversion area WCA and the reflection area RA around a rotation axis RX, so that the wavelength conversion area WCA converts the first color light L1 into a second color light L2 and reflects the second color light L2 to the first dichroic mirror 131 within a first time interval, and the reflection area RA reflects the first color light L1 to the first dichroic mirror 131 within a second time interval. In this embodiment, the second color light L2 is, for example, a yellow light, and the first dichroic mirror 131 is further configured to reflect the second color light L2, but the disclosure is not limited thereto.

For example, in this embodiment, the wavelength conversion wheel 140 includes a reflection layer 142 and a wavelength conversion layer 144 sequentially stacked on the surface 145s. The wavelength conversion layer 144 defines the wavelength conversion area WCA and is configured to convert the first color light L1 into the second color light L2, while the reflection layer 142 is, for example, a white diffuse reflection layer and is configured to diffusely reflect the second color light L2 to the first dichroic mirror 131. The surface 145s is defined as an incident surface of the substrate 145 facing the first color light L1. It should be noted that in the normal direction of the surface 145s (for example, Z direction; Z direction represents the second direction), the substrate 145 could have an opening 145op, and a mirror reflection element 143 is disposed in the opening 145op of the substrate 145. The mirror reflection element 143 defines the reflection area RA. The mirror reflection element 143 is configured to reflect the first color light L1 to the first dichroic mirror 131. More specifically, after the wavelength conversion layer 144 is excited by the first color light L1 to generate the second color light L2, the second color light L2 is reflected by the reflection layer 142 and transmitted through the wavelength conversion layer 144 to the first dichroic mirror 131.

Referring to FIG. 1 and FIG. 2, it should be particularly noted that the case 50 has a bottom surface 50bs for supporting the weight of the illumination system 100, and the wavelength conversion wheel 140 is disposed in the projection apparatus 10, so that the surface 145s of the substrate 145 of the wavelength conversion wheel 140 is parallel to the bottom surface 50bs of the case 50. More specifically, the rotation axis RX of the substrate 145 is parallel to a gravity direction GD (−Z direction). In other words, the surface 145s of the substrate 145 is perpendicular to the gravity direction GD. Since the surface 145s of the substrate 145 is parallel to the bottom surface 50bs of the case 50 of the projection apparatus 10, the stability of the wavelength conversion wheel 140 during rotation is improved, which helps reduce vibration and noise generated during the rotation process. Therefore, the stability of the light traveling path of the illumination system 100 is significantly enhanced.

Furthermore, the illumination system 100 may also include a filter module 150 disposed on the transmission paths of the first color light L1 and the second color light L2 from the first dichroic mirror 131. The formation of the first color light L1 will be described later. In this embodiment, the filter module 150 is, for example, a combination of a filter wheel and a rotation mechanism (not shown). The rotation mechanism is, for example, a motor and is configured to drive the filter wheel to rotate around a rotation axis RX”, so that multiple filter areas of the filter module 150 sequentially cut into the transmission paths of the first color light L1 and the second color light L2 from the first dichroic mirror 131, wherein the multiple filter areas include a filter area that allows blue light to pass through, a filter area that allows red light to pass through, and a filter area that allows green light to pass through, or may also include a filter area that allows yellow light to pass through, but the disclosure is not limited thereto. Blue light, red light, green light, or yellow light may leave the filter module 150 sequentially.

The aforementioned optical elements may be respectively disposed in spaces at different heights relative to the bottom surface 50bs. For example, in this embodiment, the wavelength conversion wheel 140 is close to the bottom surface 50bs. In the Z direction, the distance between the first dichroic mirror 131 and the bottom surface 50bs, the distance between the filter module 150 and the bottom surface 50bs, and the distance between the light-homogenizing element 170 and the bottom surface 50bs are greater than the distance between the wavelength conversion wheel 140 and the bottom surface 50bs. The distance between the light source module 110 and the bottom surface 50bs is greater than the distance between the first dichroic mirror 131 and the bottom surface 50bs, the distance between the filter module 150 and the bottom surface 50bs, and the distance between the light-homogenizing element 170 and the bottom surface 50bs.

In this embodiment, the illumination system 100 may also include a first reflection mirror 121 disposed on the transmission path of the first color light L1 from the light source module 110. The first color light L1 from the light source module 110 transmits along a direction (for example, Y direction; Y direction represents the first direction) perpendicular to the gravity direction GD, and after being reflected by the first reflection mirror 121, transmits along the gravity direction GD to the first dichroic mirror 131. In the gravity direction GD, the first dichroic mirror 131 is located between the first reflection mirror 121 and the wavelength conversion wheel 140, and is configured to allow the first color light L1 to pass through and reflect the second color light L2.

The first color light L1 from the first reflection mirror 121 transmits to the wavelength conversion wheel 140 after passing through the first dichroic mirror 131. Referring to FIG. 1 to FIG. 3B, within the aforementioned first time interval, the second color light L2 generated by the wavelength conversion area WCA of the wavelength conversion wheel 140 being excited by the incident first color light L1 is reflected by the reflection layer 142 to the first dichroic mirror 131, and the second color light L2 transmits along the Y direction to the filter module 150 after being reflected by the first dichroic mirror 131. Within the aforementioned second time interval, the reflection area RA (mirror reflection element 143) of the wavelength conversion wheel 140 reflects the first color light L1 from the first dichroic mirror 131 back to the first dichroic mirror 131.

In this embodiment, the illumination system 100 may also include a diffusion element 160 and a second dichroic mirror 132. The diffusion element 160 is disposed on the transmission path of the first color light L1 from the wavelength conversion wheel 140 and passing through the first dichroic mirror 131, and is configured to disrupt the characteristics of laser light and solve the problem of laser speckle. The second dichroic mirror 132 is disposed on the transmission paths of the first color light L1 from the diffusion element 160 and the second color light L2 from the first dichroic mirror 131. For example, in the gravity direction GD, the distance between the second dichroic mirror 132 and the wavelength conversion wheel 140 is less than the distance between the diffusion element 160 and the wavelength conversion wheel 140. More specifically, the distance between the second dichroic mirror 132 and the bottom surface 50bs is approximately the same as the distance between the first dichroic mirror 131 and the bottom surface 50bs. On the transmission path of the second color light L2, the second dichroic mirror 132 is located between the first dichroic mirror 131 and the filter module 150. The second dichroic mirror 132 is configured to allow the second color light L2 to pass through and reflect the first color light L1.

In this embodiment, in the gravity direction GD, the distances from the diffusion element 160 and the light source module 110 to the bottom surface 50bs are approximately the same. In order to guide the first color light L1 from the first dichroic mirror 131 to the diffusion element 160 and guide the first color light L1 passing through the diffusion element 160 to the second dichroic mirror 132, the illumination system 100 may also include a second reflection mirror 122 and a third reflection mirror 123. The first color light L1 from the reflection area RA of the wavelength conversion wheel 140 and transmitting in the opposite direction (for example, Z direction) of the gravity direction GD transmits along the Y direction to the diffusion element 160 after passing through the first dichroic mirror 131 and being reflected by the second reflection mirror 122. The first color light L1 transmits along the Y direction through the diffusion element 160, and the first color light L1 transmits along the gravity direction GD to the second dichroic mirror 132 after being reflected by the third reflection mirror 123.

The second color light L2 from the first dichroic mirror 131 transmits to the filter module 150 after passing through the second dichroic mirror 132. The first color light L1 from the diffusion element 160 transmits to the filter module 150 after being reflected by the second dichroic mirror 132. It should be noted that the optical paths of the first color light L1 and the second color light L2 overlap between the second dichroic mirror 132 and the filter module 150. In other words, the second dichroic mirror 132 may serve as a light guide element for the first color light L1 and the second color light L2.

In this embodiment, the illumination system 100 may also include a light-homogenizing element 170 disposed on the transmission path of the first color light L1 (blue light) from the filter module 150. Each color light (blue light, red light, green light, or yellow light) forms the illumination light IL after passing through the light-homogenizing element 170 in the order of time intervals. The illumination light IL includes at least one of the color lights.

In this embodiment, on the transmission path of the illumination light IL, the light-homogenizing element 170 is disposed between the filter module 150 and a light valve 300. The light-homogenizing element 170 is, for example, an integration rod, but the disclosure is not limited thereto. In other embodiments, the light-homogenizing element may be a lens array, or other optical elements with light homogenizing effects.

In this embodiment, the distances from the light source module 110, the first reflection mirror 121, the second reflection mirror 122, the third reflection mirror 123, and the diffusion element 160 to the bottom surface 50bs are approximately the same. In the Z direction, the distances from the first dichroic mirror 131, the second dichroic mirror 132, the filter module 150, and the light-homogenizing element 170 to the bottom surface 50bs are approximately the same. In the gravity direction GD, the wavelength conversion wheel 140 is disposed between each of the light source module 110, the first reflection mirror 121, the second reflection mirror 122, the third reflection mirror 123, and the diffusion element 160 and the bottom surface 50bs. The first dichroic mirror 131, the second dichroic mirror 132, the filter module 150, and the light-homogenizing element 170 are disposed between each of the light source module 110, the first reflection mirror 121, the second reflection mirror 122, the third reflection mirror 123, and the diffusion element 160 and the wavelength conversion wheel 140.

In this embodiment, the illumination system 100 may also include multiple lenses respectively disposed on the transmission paths of the first color light L1 and the second color light L2. For example, lenses 191 and 192 may be disposed on the transmission path of the first color light L1 between the light source module 110 and the first reflection mirror 121. Lenses 193 and 194 may be disposed on the transmission paths of the first color light L1 and the second color light L2 between the first dichroic mirror 131 and the wavelength conversion wheel 140. A lens 195 may be disposed on the transmission paths of the first color light L1 and the second color light L2 between the second dichroic mirror 132 and the filter module 150. However, the disclosure is not limited thereto.

Furthermore, the projection apparatus 10 also includes a prism group 200, a light valve 300, and a projection lens 400. The prism group 200 is disposed on the transmission path of the illumination light IL from the illumination system 100, and is configured to guide the illumination light IL to the light valve 300. In this embodiment, the prism group 200 may be a total internal reflection prism group (TIR prism group) including two prisms 210 and 220. The light valve 300 may be, for example, a Liquid Crystal On Silicon panel (LCoS panel), a Digital Micro-Mirror Device (DMD), or other reflective light modulators, but the disclosure is not limited thereto.

The light valve 300 is disposed on the transmission path of the illumination light IL, and is configured to convert the illumination light IL into an image beam IML. In this embodiment, in the Z direction, the distances from the light valve 300, the first dichroic mirror 131, the second dichroic mirror 132, the filter module 150, and the light-homogenizing element 170 to the bottom surface 50bs are approximately the same. More specifically, in the gravity direction GD, the light valve 300 is located between each of the light source module 110, the first reflection mirror 121, the second reflection mirror 122, the third reflection mirror 123, and the diffusion element 160 and the wavelength conversion wheel 140.

As for the method by which the light valve 300 converts the illumination light IL from the illumination system 100 into the image beam IML, the detailed steps and implementations may be sufficiently taught, suggested, and implemented by the ordinary knowledge in the relevant technical field, and therefore will not be described in detail here.

The projection lens 400 is disposed on the transmission path of the image beam IML, and is configured to project the image beam IML out of the projection apparatus 10 to a projection target (not shown) such as a screen or wall. The projection lens 400 may include, for example, a combination of one or more optical lenses with refractive power, such as various combinations of non-planar lenses including biconcave lenses, biconvex lenses, concavo-convex lenses, convexo-concave lenses, plano-convex lenses, and plano-concave lenses. In an embodiment, the projection lens 400 may also include an optical reflection lens to project the image beam IML from the light valve 300 to the projection target by reflection. The disclosure is not intended to limit the type and form of the projection lens 400.

In this embodiment, the projection apparatus 10 may also include multiple lenses and multiple reflection mirrors. For example, on the transmission path of the illumination light IL between the illumination system 100 and the prism group 200, along the transmission direction, a lens 196, a lens 197, a fourth reflection mirror 124, a lens 198, a fifth reflection mirror 125, and a lens 199 are sequentially arranged. It should be noted that, in this embodiment, the distances from the lens 196, the lens 197, and the fourth reflection mirror 124 to the bottom surface 50bs are approximately the same as the distances from the first dichroic mirror 131 and the second dichroic mirror 132 to the bottom surface 50bs, while the distance from the fifth reflection mirror 125 to the bottom surface 50bs is approximately the same as the distance from the wavelength conversion wheel 140 to the bottom surface 50bs.

The illumination light IL from the light-homogenizing element 170 and transmitting along the Y direction is reflected by the fourth reflection mirror 124 and then transmits to the fifth reflection mirror 125 in a direction that is not parallel to the gravity direction GD, not parallel to the X direction (X direction represents the third direction), and not parallel to the Y direction. More specifically, the optical path of the illumination light IL between the fourth reflection mirror 124 and the fifth reflection mirror 125 is inclined to the XY plane and the XZ plane. After being reflected by the fifth reflection mirror 125, the illumination light IL passes through the lens 199 and transmits to the prism group 200. Through the aforementioned configuration relationship of the fourth reflection mirror 124 and the fifth reflection mirror 125, the arrangement of the illumination system 100, the prism group 200, the light valve 300, and the projection lens 400 inside the case 50 can be made more compact. Especially the occupied space in the Y direction is further reduced, thereby reducing the overall size of the projection apparatus 10.

In this embodiment, the light valve 300 has a light modulation surface 300s parallel to the gravity direction GD, and the light modulation surface 300s is perpendicular to the bottom surface 50bs. The light modulation surface 300s has a first edge 300e1 and a second edge 300e2 perpendicular to each other. The first edge 300e1 is substantially parallel to the bottom surface 50bs. Due to the aforementioned configuration relationship of the fourth reflection mirror 124 and the fifth reflection mirror 125, the orthographic projection of the optical path of the illumination light IL between the prism group 200 and the light valve 300 on the light modulation surface 300s is not parallel to the first edge 300e1 and the second edge 300e2, and the orthographic projection of the optical path of the illumination light IL between the prism group 200 and the light valve 300 on the light modulation surface 300s is not perpendicular to the first edge 300e1 and the second edge 300e2, either. In other words, through the guidance of the prism group 200, the orthographic projection of the illumination light IL on the light modulation surface 300s is not parallel to the first edge 300e1 and the second edge 300e2, and through the guidance of the prism group 200, the orthographic projection of the illumination light IL on the light modulation surface 300s is not perpendicular to the first edge 300e1 and the second edge 300e2, either.

Provided below are some other embodiments for illustrating the disclosure in detail, in which the same components will be denoted by the same reference numerals, and the description of the same technical content will be omitted. Please refer to the aforementioned embodiments for the omitted content, which will not be repeated below.

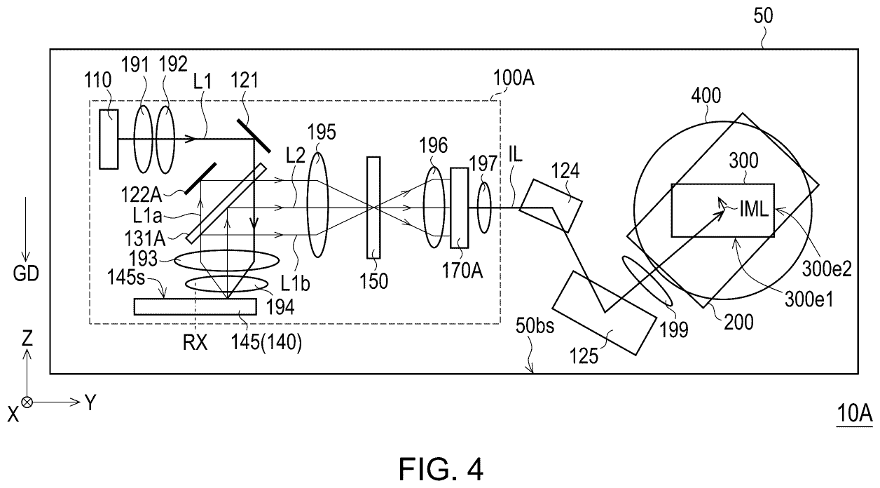

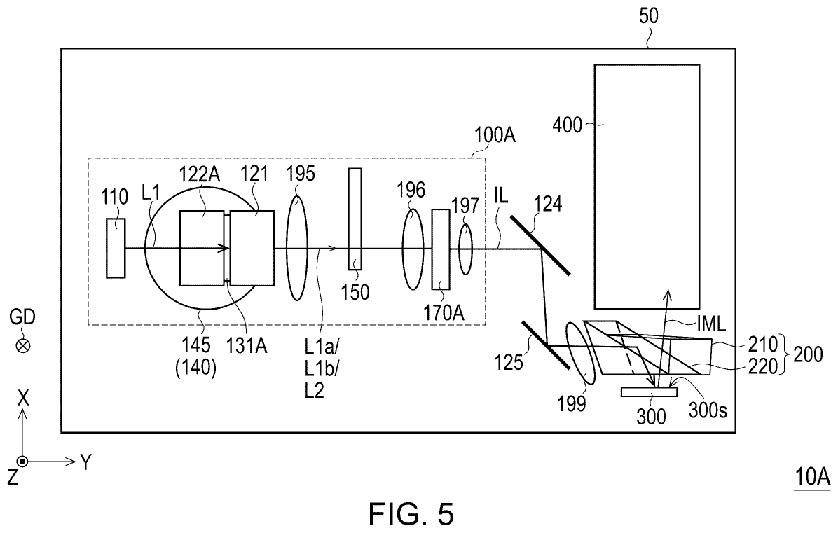

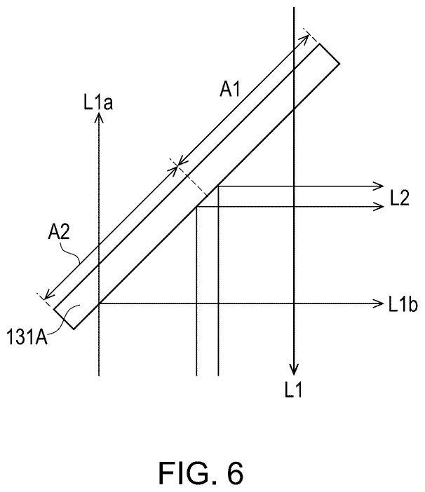

FIG. 4 is a schematic side view of the projection apparatus according to the second embodiment of the disclosure. FIG. 5 is a schematic top view of the projection apparatus according to the second embodiment of the disclosure. FIG. 6 is an enlarged schematic view of the first dichroic mirror in FIG. 4 and FIG. 5. For clarity, FIG. 5 omits the illustration of the lens 191 and the lens 192 shown in FIG. 4.

Referring to FIG. 4 and FIG. 5, the main differences between the projection apparatus 10A of this embodiment and the projection apparatus 10 in FIG. 1 and FIG. 2 lie in that: the transmission path of the first color light of the illumination system within the case is different, and the way the first dichroic mirror acts on the first color light is different. Specifically, in the projection apparatus 10A of this embodiment, the illumination system 100A has two reflection mirrors and one dichroic mirror, which are a first reflection mirror 121, a second reflection mirror 122A, and a first dichroic mirror 131A.

It should be particularly noted that in this embodiment, in the Z direction, the distances from the first reflection mirror 121 and the second reflection mirror 122A to the bottom surface 50bs are not the same. The distances from the second reflection mirror 122A, the first dichroic mirror 131A, the filter module 150, and the light-homogenizing element 170A (for example, a lens array) to the bottom surface 50bs are approximately the same. More specifically, in the gravity direction GD, the second reflection mirror 122A, the first dichroic mirror 131A, the filter module 150, the light-homogenizing element 170A, and the light valve 300 are disposed between each of the light source module 110 and the first reflection mirror 121, and the wavelength conversion wheel 140. Furthermore, in the Z direction, the distance between the first reflection mirror 121 and the bottom surface 50bs is greater than the distance between the second reflection mirror 122A and the bottom surface 50bs. The distance between the first dichroic mirror 131A and the bottom surface 50bs is greater than the distance between the wavelength conversion wheel 140 and the bottom surface 50bs.

Referring to FIG. 4 and FIG. 6, in this embodiment, the first dichroic mirror 131A may have a first area A1 and a second area A2. The first area A1 is located on the transmission path of the first color light L1 from the light source module 110. The second area A2 is located on the transmission path of the first color light L1 from the reflection area RA of the wavelength conversion wheel 140. The first area A1 is configured to allow the first color light L1 from the light source module 110 to pass through and reflect the second color light L2 from the wavelength conversion area WCA of the wavelength conversion wheel 140. The second area A2 is configured to allow a portion of the first color light L1 (that is, a first portion of the first color light L1a) from the reflection area RA of the wavelength conversion wheel 140 to pass through and reflect another portion of the first color light L1 (that is, a second portion of the first color light L1b) and the second color light L2.

In this embodiment, the second reflection mirror 122A is disposed on the transmission path of the first portion of the first color light L1a from the first dichroic mirror 131A. The second portion of the first color light L1b is reflected by the second area A2 of the first dichroic mirror 131A and then transmits along the Y direction to the filter module 150. The first portion of the first color light L1a, after passing through the second area A2 of the first dichroic mirror 131A and being reflected by the second reflection mirror 122A, transmits along the Y direction to the filter module 150.

It should be particularly noted that, after being reflected by the second reflection mirror 122A, the first portion of the first color light L1a first passes through the first area A1 of the first dichroic mirror 131A and then transmits to the filter module 150. The lens 195 disposed between the first dichroic mirror 131A and the filter module 150 is configured to focus the first portion of the first color light L1a, the second portion of the first color light L1b, and the second color light L2 on the filter module 150.

On the other hand, in this embodiment, the light-homogenizing element 170A is, for example, a lens array, and the light-homogenizing element 170A has lenses 196 and 197 disposed on two opposite sides along the Y direction.

Since the optical path design of the illumination light IL between the illumination system 100A, the prism group 200, the light valve 300, and the projection lens 400 in this embodiment is similar to that of the projection apparatus 10 in FIG. 1 and FIG. 2, please refer to the aforementioned embodiment for details, which will not be repeated here.

It should be noted that the number of lenses disposed between the illumination system and the prism group in the projection apparatus may be adjusted according to different optical designs, and the disclosure is not intended to impose any limitation. For example, the number of lenses disposed on the optical path between the illumination system 100A and the prism group 200 in the projection apparatus 10A of this embodiment may be different from that in the projection apparatus 10 in FIG. 1.

In another embodiment, the second area A2 of the first dichroic mirror 131A may reflect all the first color light L1 from the reflection area RA of the wavelength conversion wheel 140 to the filter module 150. In other words, in this embodiment, the illumination system may not require the second reflection mirror 122A.

In summary, in the projection apparatus of an embodiment of the disclosure, the substrate of the wavelength conversion wheel is provided with the reflection area for reflecting the first color light emitted by the light source module and the wavelength conversion area for converting the first color light into the second color light. Since the surface of the substrate is parallel to the bottom surface of the case of the projection apparatus, the stability of the wavelength conversion wheel during rotation is improved, which helps reduce vibration and noise generated during the rotation process. In addition, the number of optical elements to be disposed is reduced, thereby reducing the overall size of the projection apparatus.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A projection apparatus, comprising:
a case;
an illumination system disposed in the case, the illumination system is configured to provide an illumination light, and the illumination system comprises a light source module and a wavelength conversion wheel,
wherein the light source module is configured to provide a first color light, and
the wavelength conversion wheel is disposed on a transmission path of the first color light, the wavelength conversion wheel comprises a substrate, a surface of the substrate is provided with a wavelength conversion area, and the wavelength conversion area is configured to convert the first color light into a second color light;
a light valve disposed on a transmission path of the illumination light and configured to convert the illumination light into an image beam; and
a projection lens disposed on a transmission path of the image beam and configured to project the image beam out of the projection apparatus, wherein the surface of the substrate is parallel to a bottom surface of the case, and the bottom surface of the case is configured to support a weight of the illumination system.

2. The projection apparatus according to claim 1, wherein the illumination system further comprises a first dichroic mirror, the first dichroic mirror is disposed on the transmission path of the first color light, and the wavelength conversion wheel is disposed on the transmission path of the first color light from the first dichroic mirror.

3. The projection apparatus according to claim 2, wherein the substrate further comprises a reflection area, and the reflection area is configured to reflect the first color light, wherein the substrate is configured to drive the wavelength conversion area and the reflection area to rotate around a rotation axis, so that the wavelength conversion area converts the first color light into the second color light and reflects the second color light to the first dichroic mirror within a first time interval, and the reflection area reflects the first color light to the first dichroic mirror within a second time interval, wherein the rotation axis is parallel to a gravity direction.

4. The projection apparatus according to claim 3, wherein the illumination system further comprises a filter module, and the filter module is disposed on transmission paths of the second color light and the first color light from the first dichroic mirror.

5. The projection apparatus according to claim 4, wherein the illumination system further comprises a light-homogenizing element on the transmission path of the illumination light, and the light-homogenizing element is disposed between the filter module and the light valve.

6. The projection apparatus according to claim 5, further comprising:
a prism group disposed on the transmission path of the illumination light and configured to guide the illumination light to the light valve.

7. The projection apparatus according to claim 6, wherein the light valve has a light modulation surface parallel to the gravity direction, the light modulation surface is perpendicular to the bottom surface of the case, the light modulation surface has a first edge and a second edge perpendicular to each other, the first edge is parallel to the bottom surface of the case, and an orthographic projection of an optical path of the illumination light from the prism group on the light modulation surface is not parallel to the first edge and the second edge.

8. The projection apparatus according to claim 5, wherein the illumination system further comprises a first reflection mirror disposed on the transmission path of the first color light from the light source module, wherein the first color light from the light source module transmits along a first direction, and transmits along the gravity direction to the first dichroic mirror after being reflected by the first reflection mirror.

9. The projection apparatus according to claim 8, wherein in the gravity direction, the first dichroic mirror is located between the first reflection mirror and the wavelength conversion wheel, and configured to allow the first color light to pass through and reflect the second color light.

10. The projection apparatus according to claim 9, wherein the second color light from the wavelength conversion wheel transmits along the first direction to the filter module after being reflected by the first dichroic mirror.

11. The projection apparatus according to claim 10, wherein the illumination system further comprises a diffusion element disposed on the transmission path of the first color light from the wavelength conversion wheel.

12. The projection apparatus according to claim 11, wherein the illumination system further comprises a second dichroic mirror disposed on the transmission path of the first color light from the diffusion element, wherein the second color light from the first dichroic mirror passes through the second dichroic mirror and transmits to the filter module, and the first color light from the diffusion element transmits to the filter module after being reflected by the second dichroic mirror.

13. The projection apparatus according to claim 12, wherein the illumination system further comprises a second reflection mirror and a third reflection mirror, wherein the second reflection mirror is configured to reflect the first color light from the wavelength conversion wheel to the diffusion element, and the third reflection mirror is configured to reflect the first color light passing through the diffusion element to the second dichroic mirror.

14. The projection apparatus according to claim 1, wherein in a gravity direction, the wavelength conversion wheel is disposed between the light source module and the bottom surface of the case.

15. The projection apparatus according to claim 2, wherein the first dichroic mirror has a first area and a second area, the first area is configured to allow the first color light to pass through and reflect the second color light, the second area is configured to allow a first portion of the first color light from the wavelength conversion wheel to pass through and reflect a second portion of the first color light from the wavelength conversion wheel and the second color light.

16. The projection apparatus according to claim 15, wherein the illumination system further comprises a second reflection mirror, and the second reflection mirror is configured to reflect the first portion of the first color light passing through the second area of the first dichroic mirror.
